(19) United States
(12) Patent Application Publication
(10) Pub. No.: US 2012/0298773 A1
(43) Pub. Date: Nov. 29, 2012

(54) AUTOMATICALLY SWINGING HOLDER

(75) Inventors: Huasong Zhou, Xiamen (CN); Shuiyuan Luo, Xiamen (CN); Jianmin Chen, Xiamen (CN); Bin Chen, Xiamen (CN)

(73) Assignees: Xiamen Solex High-Tech Industries, Xiamen Fujian (CN); Huasong Zhou, Xiamen Fuian (CN)

(21) Appl. No.: 13/519,382

(22) PCT Filed: Jan. 24, 2011
(86) PCT No.: PCT/CN2011/070522

§ 371 Date: Jun. 27, 2012

(30) Foreign Application Priority Data
Feb. 5, 2010 (CN) 2010101246227
Feb. 5, 2010 (JP) 2010201334859

(51) Int. Cl. B05B 3/14

(52) U.S. Cl. 239/274

(57) ABSTRACT

An automatically swinging holder includes a body, a socket and a driving mechanism. The body is disposed with an impact cavity for the water flowing; the socket is swinging connected to the body, the socket can plugged connected to the outlet terminal; and the driving mechanism includes an impeller and an actuator, the impeller is pivot connected to the impact cavity inside and can be rotated with the impact of the water flowing along the impact cavity; the actuator is connected between the to impeller and the socket to transmit the rotation of the impeller to the swinging of the socket. The socket is swinging by the driving of the water force to drive the odds in the socket to swing, such as the handheld shower, which increases the shower area and enhances the comfort of shower further with message effect.

### FIELD OF THE INVENTION

The present invention relates to a bathroom device, especially to an automatically swinging holder used in the bathroom device.

### BACKGROUND OF THE INVENTION

The existing handheld shower of the bathroom device is usually connected to the holder fixed on the wall. As the holder is fixed, the handheld shower placed in the holder is fixed as well.

### SUMMARY OF THE INVENTION

The present invention is provided with an automatically swinging holder, which overcomes the disadvantage of the existing holder of fixed. The technical proposal of the present invention is:

An automatically swinging holder includes:

A body, with an impact cavity for the water flowing;

A socket, which is swinging connected to the body, the socket can plugged connected to the outlet terminal; and

A driving mechanism, which includes an impeller and an actuator, the impeller is pivot connected to the impact cavity inside and can be rotated with the impact of the water flowing along the impact cavity; the actuator is connected between the impeller and the socket to transmit the rotation of the impeller to the swinging of the socket.

In another preferred embodiment, the actuator includes:

A crank and rocker mechanism, which includes:

A pendulum shaft rotatably connected to the body, the pendulum shaft is fixed to the socket;

A pendulum rod, which is fixed to the pendulum shaft, the pendulum rod is disposed with a lengthwise groove; and

A rotor wheel rotatably connected to the body, the rotor wheel is fixed with a eccentric shaft, the eccentric shaft is coupled to connected to the lengthwise groove of the pendulum rod;

A deceleration system connected between the impeller and the rotor wheel.

In another preferred embodiment, the pendulum rod is disposed with a connection section and a grooving section, the centre of the end of the connection section is concaved to formed a folktailed end, the lengthwise groove is opened in the grooving section; the right and left side of the centre of the pendulum shaft are separately concaved to form a connection groove, the folktailed end of the pendulum shaft is coupled to connect to the two connection grooves of the pendulum shaft, making the pendulum shaft and the pendulum rod formed a connection relationship of synchronized rotation.

In another preferred embodiment, the impeller is fixed with a connection shaft, a worm is fixed external to the connection shaft; the deceleration system includes a turbine engaged to the worm and a small gear fixed to the turbine with coaxial junction, the rotor wheel is a gear, the rotor wheel is engaged to the small gear.

In another preferred embodiment, a switch is disposed on the body; the switch is disposed to control the rotation of the impeller.

In another preferred embodiment, the switch is a pin sealed connected to the body, the switch is sliding connected to the body and sliding between a first position and a second position, the first position is the position the pin away from the impeller to make the impeller free rotating, the second position is the position the pin withstood the impeller to limit the rotation of the impeller.

In another preferred embodiment, the switch is a water flowing control device, the body is disposed with two independent waterways inside, the impeller is disposed inside one of the independent waterway, which independent waterway is selected for the water flowing is controlled by the switch, if the water is flowing through the independent waterway with impeller, the impeller rotates to drives the socket swinging, if the other, the impeller keeps still.

In another preferred embodiment, the impeller includes a central element and several blades fixed external of the central element, the lower portion of the blades is disposed with a breach.

In another preferred embodiment, the body includes a fixed base, a connection base fixed to the side wall of the fixed base, a side cover and an upper cover, the reverse side of the fixed base is concaved to form the inlet groove, the side cover is sealed fixed to the opening of the inlet groove of the fixed base to form the impact cavity, an inlet connected to the inlet groove and an outlet connected to the inlet groove are disposed to on the fixed base; the top surface of the connection base is concaved to form an assembly groove, the upper cover is sealed fixed to the opening of the assembly groove; the connection shaft is rotatably connected to the body, the lower end of the connection shaft is extended into the inlet groove and fixed to the impeller, the upper end of the connection shaft is extended into the assembly groove and fixed to the turbine.

Compared to the existing technology, the present invention has advantages below: firstly, the socket is swinging by the driving of the water force to drive the odds in the socket to swing, such as the handheld shower, which increases the shower area and enhances the comfort of shower further with message effect, the present invention is applicable for every kind of shower or outlet terminal; secondly, the socket is swinging by the driving of the water force without other driving mechanism with lower cost and energy saving; thirdly, the present invention is continuing swinging at the continuously water flowing; fourthly, the deceleration is realized by the cooperation of the worm and the turbine with the big and small gears, obtaining high torque and proper rotation; fifthly, the unidirectional rotation of the impeller is transmitted to back-to-fro swinging by the crank and rocker mechanism with simple structure; sixthly, the switch is disposed for the swinging controlling by the user; seventhly, the switch is a pin, the rotation of the impeller is controlled by the sliding of the pin to realize the swinging of the pendulum rod, the control structure is simple; eighthly, the folktailed end of the pendulum rod is coupled to connect to the two connection grooves of the pendulum shaft, making the pendulum shaft and the pendulum rod formed a connection relationship of synchronized rotation, the present invention is easy to assemble; ninthly, the body includes a connection base, a connection base, a side cover and an upper cover, the assemble is convenience with well sealing.

### BRIEF DESCRIPTION OF THE DRAWINGS

The present invention is further described with the drawings and the embodiments.

FIG. 1 illustrates the structure of the automatically swinging holder;

FIG. 2 illustrates the breakdown structure of the automatically swinging holder;

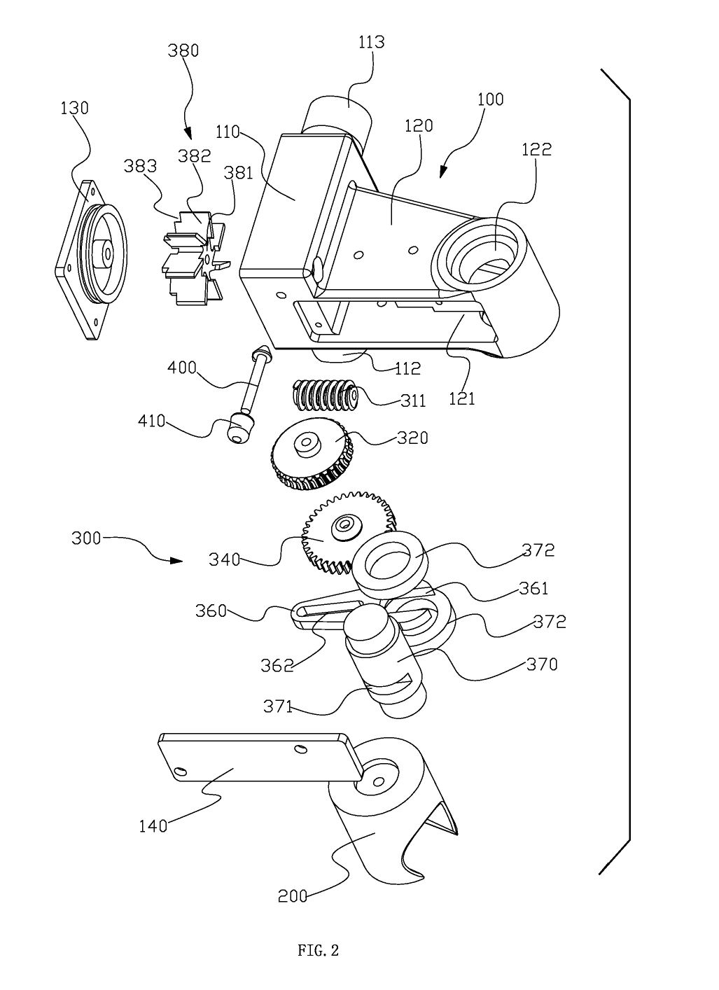

FIG. 3 illustrates the side view of the automatically swinging holder;

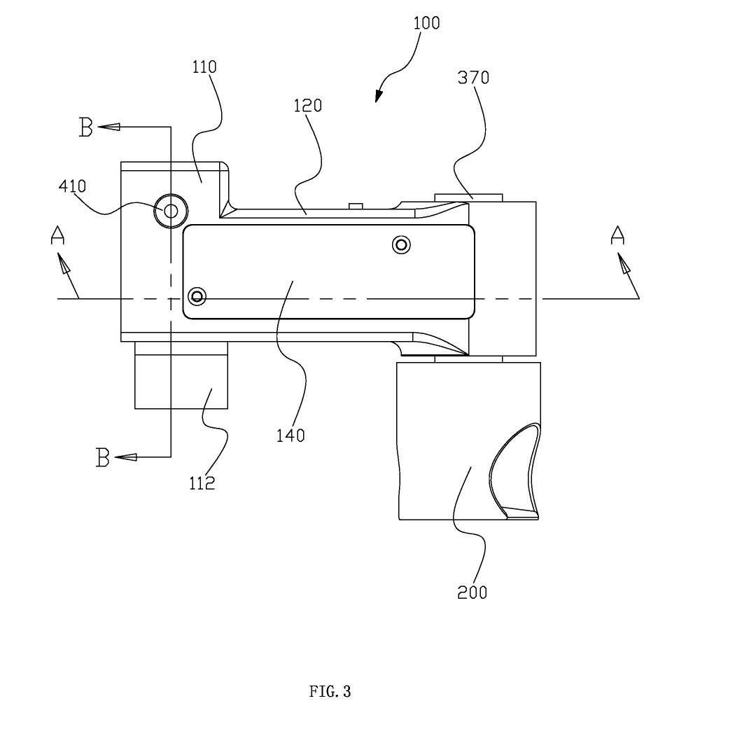

FIG. 4 illustrates the sectional view of the A-A part of the FIG. 3;

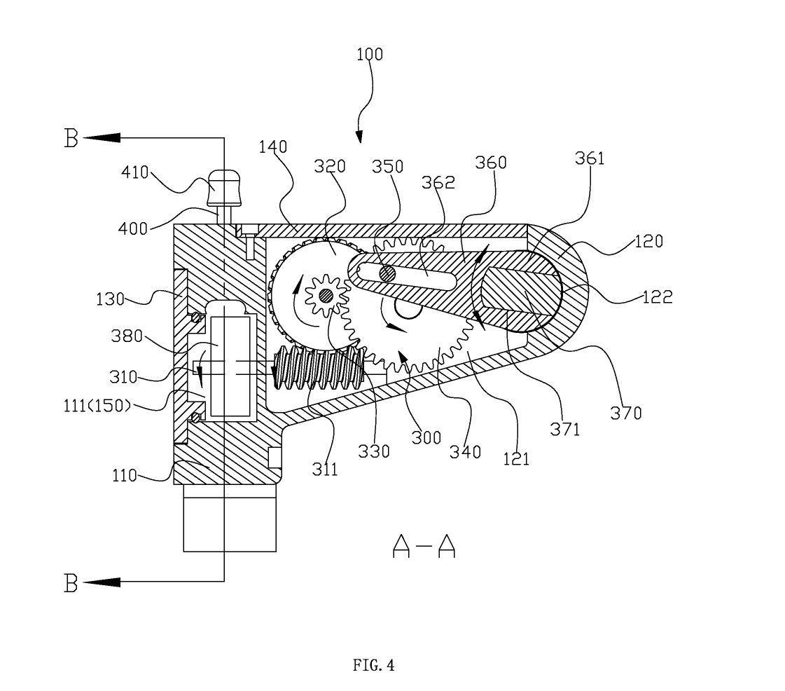

FIG. 5 illustrates the sectional view of the B-B part of the FIG. 3 when the pin is situated in the first position;

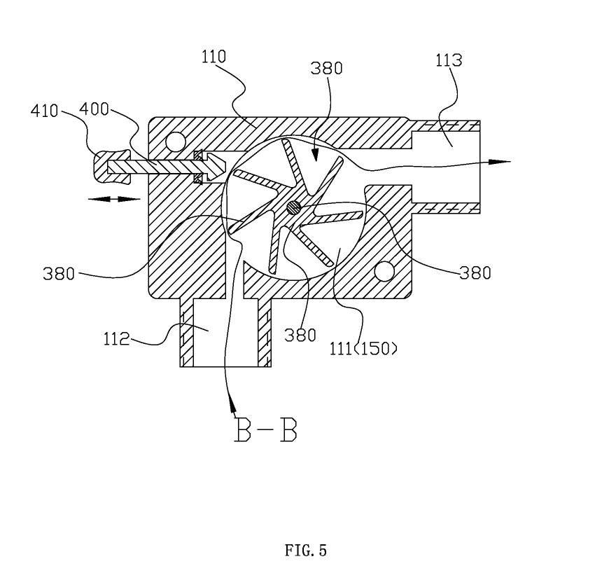

FIG. 6 illustrates the sectional view of the B-B part of the FIG. 3 when the pin is situated in the second position;

The reference signs description:

The body 100, the socket 200, the driving mechanism 300, the fixed base 110, the connection base 120, the side cover 130, the upper cover 140, the inlet groove 111, the impact cavity 150, the inlet 112, the outlet 113, the assembly groove 121, the pivot hole 122, the impeller 380, the connection shaft 310, the worm 320, the small gear 330, the big gear 340, the eccentric shaft 350, the pendulum rod 360, the pendulum shaft 370, the centre element 381, the blade 382, the breach 383, the turbine 311, the connection groove 371, the folktailed end 361, the lengthwise groove 362, the pin 400, the handle 410, the bearing 372.

### DETAILED DESCRIPTION OF THE EMBODIMENT

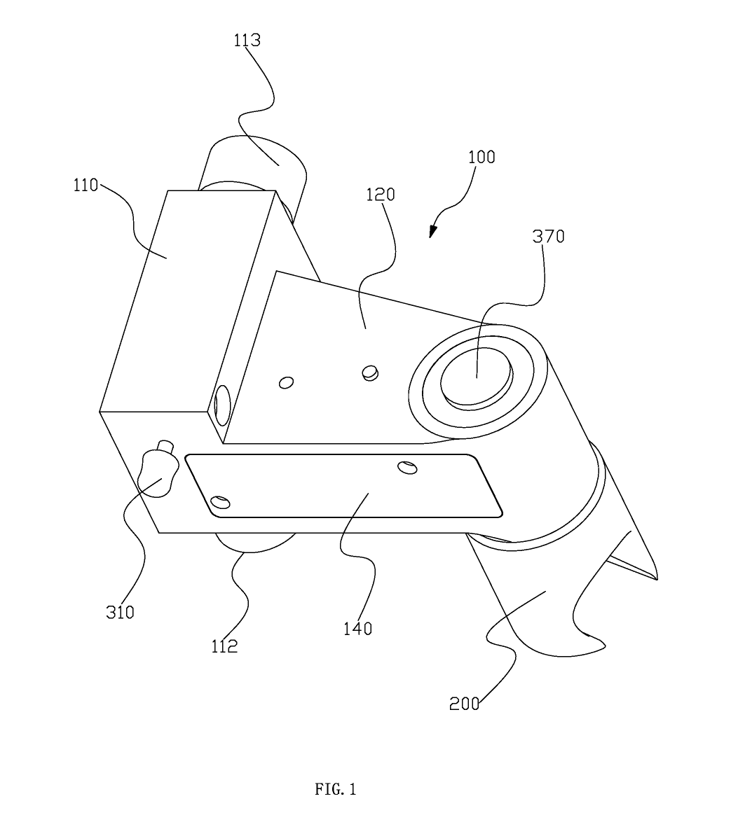

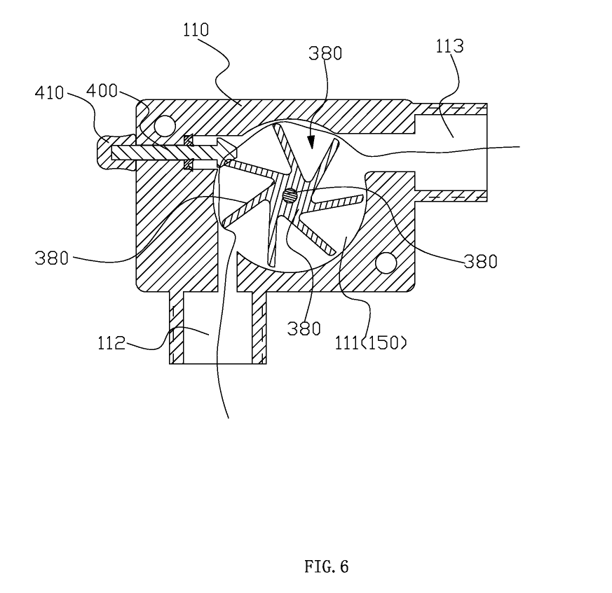

Please refer to the FIG. 1 and FIG. 6, an automatically swinging holder includes a body 100, a socket 200 and a driving mechanism 300.

The body 100 includes a fixed base 110 fixed to the wall, a connection base 120 fixed to the side of the fixed base 110, a side cover 130 and an upper cover 140. the reverse side of the fixed base 110 is concaved to form the inlet groove 1111; the side cover 130 is sealed fixed to the opening of the inlet groove 111 to form the impact cavity 150; the fixed base 110 is disposed with an inlet 112 connected to the inlet groove 111 and an outlet 113 connected to the inlet groove 111; the inlet 112 is connected to the water source, the outlet 113 is connected to the outlet terminal, such as a handheld shower. The side of the connection base 120 is concaved to form the assembly groove 121; the upper cover 140 is sealed fixed to the opening of the assembly groove 121. The end of the connection base 120 is disposed with a pivot hole 122 of through connected to the assembly groove 121.

The driving mechanism 300 includes an impeller 380, a connection shaft 310, a worm 320, a small gear 320, a big gear 340, a eccentric shaft 350, a pendulum rod 360 and a pendulum shaft 370.

The impeller 380 is pivot connected to the body and situated inside the impact cavity 150. The impeller 380 rotates with the water flowing through the impact cavity 150 of the body 100. In this embodiment, the impeller 380 includes a centre element 371 and several blades 382 disposed external of the centre element 381. The lower of the blades 382 is disposed with breach 383, which is provided to prevent the water-retaining by the blades 382.

The connection shaft 310 is rotatably connected to the body 100; the lower end of the connection shaft 310 is extended into the inlet groove 111 and fixed to the centre element 381 of the impeller 380; the upper end of the connection shaft 310 is extended into the assembly groove 121. the portion of the connection shaft 310 disposed inside the assembly groove 121 is fixed with the worm 311.

The turbine 320 is rotatably disposed inside the assembly groove 121 of the connection base 120 and engaged to the worm 311 of the connection shaft 310.

The small gear 330 is fixed to the turbine 320 with coaxial junction.

The big gear 340 is rotatably connected to the assembly groove 121 of the connection base 120 inside and engaged to the small gear 330. In this embodiment, the number of the teeth of the big gear 340 is more than that of the small gear 330.

The eccentric shaft 350 is fixed in the eccentric position of the big gear 340.

The pendulum shaft 370 is sealed rotatably connected to the pivot hole 122 of the connection base 120 through the bearing 372 with an extended portion extended out of the connection base 120. the centric portion of the pendulum shaft 370 and the left and right portion of the pendulum shaft 370 inside the assembly groove 121 are separately concaved to form the connection groove 371.

The pendulum rod 360 includes a connection section and a grooving section, the centre of the end of the connection section is concaved to form a folktailed end 361, and a lengthwise groove 362 is opened in the grooving section.

The right and left side of the centre of the pendulum shaft are separately concaved to form a connection groove, the folktailed end of the pendulum shaft is coupled to connect to the two connection grooves of the pendulum shaft, making the pendulum shaft and the pendulum rod formed a connection relationship of synchronized rotation.

The pendulum shaft 370, the pendulum rod 360, the eccentric shaft 350 and the big gear 340 are coupled to form the crank and rocker mechanism, which is applied to transmit the rotation of the big gear 340 to small angle pendulum of the pendulum shaft 370. The turbine 320, the small gear 330 and the big gear 340 are coupled to form the deceleration system, which is applied to decrease the high speed rotation of the impeller 380 to low speed and make the impeller 380 obtaining high torque.

The extended portion the socket 200 fixed to the pendulum shaft 370 makes the socket 200 and the body 100 to be the pendulum connection to connect to the water source.

In this embodiment, the driving process of the driving mechanism 300 includes: the water flowing impacts the impeller 380 to make it rotating; the impeller 380 drives the connection shaft 310 rotating; the connection shaft 310 drives the worm 311 rotating; the worm 311 drives the turbine 320 rotating; the turbine 320 drives the small gear 330 rotating; the small gear 330 drives the big gear 340 rotating; the big gear 340 drives the eccentric shaft 350 rotating about the axis of the big gear 340 to drive the pendulum rod 360 swinging in a small angle and the pendulum shaft 370 swinging in a small angle and the socket 200 swinging in a small angle and then the handheld shower swinging in a small angle. In this embodiment, the swinging direction is up and down, making the socket swinging like heading and nodding. But not limited, other swinging directions such as left and right are applicable, making the socket swinging like shaking the head.

In this embodiment, the body 100 is disposed with a switch, which is a pin 400 sealed connected to the fixed base 110 of the body 100 and extended into the inlet groove 111. the switch is sliding connected to the body 100 and sliding between a first position and a second position, the first position is the position the pin 400 away from the impeller 380 to make the impeller 380 free rotating, the second position is the position the pin 400 withstood the impeller 380 to limit the rotating of the impeller 380. The end of the pin 400 is disposed with a handle 410.

In this embodiment, the pin 400 is disposed to control the rotating of the impeller 380 to control the swinging of the socket 200, but not limited to this, other methods such as the water flowing to control are applicable. The water flowing controlling is: the body is disposed with two independent waterways; the impeller is disposed inside one of the independent waterway, which independent waterway the water flowing through is controlled by the switch. If the water is flowing through the waterway with impeller, the impeller rotates and drives the socket 200 swinging, otherwise, the impeller is kept still without the force of the water flowing.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

### INDUSTRIAL APPLICABILITY

The present invention is provided with an automatically swinging holder. The socket is swinging by the driving of the water force to drive the odds in the socket to swing, such as the handheld shower, which increases the shower area and enhances the comfort of shower further with message effect. The present invention is applicable for every kind of shower or outlet terminal without other driving mechanisms with lower cost and energy saving.

What is claimed is:

1. An automatically swinging holder, wherein includes:
A body, with an impact cavity for the water flowing;
A socket, which is swinging connected to the body, the socket can plugged connected to the outlet terminal; and
A driving mechanism, which includes an impeller and an actuator, the impeller is pivot connected to the impact cavity inside and can be rotated with the impact of the water flowing through the impact cavity; the actuator is connected between the impeller and the socket to transmit the rotation of the impeller to the swinging of the socket.

2. An automatically swinging holder according to the claim 1, wherein the actuator includes:
A crank and rocker mechanism, which includes:
A pendulum shaft rotatably connected to the body, the pendulum shaft is fixed to the socket;
A pendulum rod, which is fixed to the pendulum shaft, the pendulum rod is disposed with a lengthwise groove; and
A rotor wheel roratably connected to the body, the rotor wheel is fixed with a eccentric shaft, the eccentric shaft is coupled to connected to the lengthwise groove of the pendulum rod;
A deceleration system connected between the impeller and the rotor wheel.

3. An automatically swinging holder according to the claim 2, wherein the pendulum rod is disposed with a connection section and a grooving section, the centre of the end of the connection section is concaved to formed a folktailed end, the lengthwise groove is opened in the grooving section; the right and left side of the centre of the pendulum shaft are separately concaved to form a connection groove, the folktailed end of the pendulum shaft is coupled to connect to the two connection grooves of the pendulum shaft, making the pendulum shaft and the pendulum rod formed a connection relationship of synchronized rotation.

4. An automatically swinging holder according to the claim 2, wherein the impeller is fixed with a connection shaft, a worm is fixed external to the connection shaft; the deceleration system includes a turbine engaged to the worm and a small gear fixed to the turbine with coaxial junction, the rotor wheel is a gear, the rotor wheel is engaged to the small gear.

5. An automatically swinging holder according to claim 2, wherein a switch is disposed on the body, the switch is disposed to control the rotation of the impeller.

6. An automatically swinging holder according to the claim 5, wherein the switch is a pin sealed connected to the body, the switch is sliding connected to the body and sliding between a first position and a second position, the first position is the position the pin away from the impeller to make the impeller free rotating, the second position is the position the pin withstood the impeller to limit the rotation of the impeller.

7. An automatically swinging holder according to the claim 1, wherein the impeller includes a central element and several blades fixed external of the central element, the lower portion of the blades is disposed with a breach.

8. An automatically swinging holder according to the claim 4, wherein the body includes a fixed base, a connection base fixed to the side wall of the fixed base, a side cover and an upper cover, the reverse side of the fixed base is concaved to form the inlet groove, the side cover is sealed fixed to the opening of the inlet groove of the fixed base to form the impact cavity, an inlet connected to the inlet groove and an outlet connected to the inlet groove are disposed on the fixed base; the top surface of the connection base is concaved to form an assembly groove, the upper cover is sealed fixed to the opening of the assembly groove; the connection shaft is rotatably connected to the body, the lower end of the connection shaft is extended into the inlet groove and fixed to the impeller, the upper end of the connection shaft is extended into the assembly groove and fixed to the turbine.

9. An automatically swinging holder according to the claim 5, wherein the switch is a water flowing control device, the body is disposed with two independent waterways inside, the impeller is disposed inside one of the independent waterway, which independent waterway is selected for the water flowing is controlled by the switch, if the water is flowing through the independent waterway with impeller, the impeller rotates to drives the socket swinging, if the other, the impeller keeps still.

10. An automatically swinging holder according to, claim 3, wherein a switch is disposed on the body, the switch is disposed to control the rotation of the impeller.

11. An automatically swinging holder according to, claim 4, wherein a switch is disposed on the body, the switch is disposed to control the rotation of the impeller.

12. An automatically swinging holder according to the claim 10, wherein the switch is a pin sealed connected to the body, the switch is sliding connected to the body and sliding between a first position and a second position, the first position is the position the pin away from the impeller to make the impeller free rotating, the second position is the position the pin withstood the impeller to limit the rotation of the impeller.

13. An automatically swinging holder according to the claim 11, wherein the switch is a pin sealed connected to the body, the switch is sliding connected to the body and sliding between a first position and a second position, the first position is the position the pin away from the impeller to make the impeller free rotating, the second position is the position the pin withstood the impeller to limit the rotation of the impeller.

14. An automatically swinging holder according to the claim 2, wherein the impeller includes a central element and several blades fixed external of the central element, the lower portion of the blades is disposed with a breach.

15. An automatically swinging holder according to the claim 3, wherein the impeller includes a central element and several blades fixed external of the central element, the lower portion of the blades is disposed with a breach.

16. An automatically swinging holder according to the claim 4, wherein the impeller includes a central element and several blades fixed external of the central element, the lower portion of the blades is disposed with a breach.

17. An automatically swinging holder according to the claim 10, wherein the switch is a water flowing control device, the body is disposed with two independent waterways inside, the impeller is disposed inside one of the independent waterway, which independent waterway is selected for the water flowing is controlled by the switch, if the water is flowing through the independent waterway with impeller, the impeller rotates to drives the socket swinging, if the other, the impeller keeps still.

18. An automatically swinging holder according to the claim 11, wherein the switch is a water flowing control device, the body is disposed with two independent waterways inside, the impeller is disposed inside one of the independent waterway, which independent waterway is selected for the water flowing is controlled by the switch, if the water is flowing through the independent waterway with impeller, the impeller rotates to drives the socket swinging, if the other, the impeller keeps still.
